(19) United States
(12) Patent Application Publication
(10) Pub. No.: US 2013/0155245 A1
(43) Pub. Date: Jun. 20, 2013

(54) System For Remote Communications Between Scout And Monitor

(71) Applicant: Milan Slamka, Camas, WA (US)

(72) Inventor: Milan Slamka, Camas, WA (US)

(21) Appl. No.: 13/770,870

(22) Filed: Feb. 19, 2013

Related U.S. Application Data
(63) Continuation-in-part of application No. 13/297,572, filed on Nov. 16, 2011.
Application No. 13/297,572 is a continuation-in-part of application No. 12/870,458, filed on Aug. 27, 2010.
(60) Provisional application No. 61/600,940, filed on Feb. 20, 2012.
(60) Provisional application No. 61/708,804, filed on Oct. 2, 2012.
(60) Provisional application No. 61/414,290, filed on Nov. 16, 2010.

(51) Int. Cl. H04N 7/18

(52) U.S. Cl. CPC H04N 7/185
USPC 348/158

(57) ABSTRACT

A communications system that provides two-way communication between a monitoring user and at least one scout is disclosed. With a camera, the scout gathers one or more images of an area that is immediate to the scout but remote from the monitoring user, and these images are communicated to the monitoring user. The monitoring user also communicates information to the scout.

### CROSS-REFERENCE TO RELATED APPLICATIONS

This application claims the benefit of U.S. Provisional Application No. 61/600,940, filed on Feb. 20, 2012 and U.S. Provisional Application No. 61/708,804, filed on Oct. 2, 2012. This application is also a continuation-in-part of U.S. patent application Ser. No. 13/297,572, filed on Nov. 16, 2011, which is a continuation-in-part of U.S. patent application Ser. No. 12/870,458, filed Aug. 27, 2010, and which also claims priority to U.S. Provisional Patent Application No. 61/414,290, filed Nov. 16, 2010. The entire disclosures of each of the above applications are incorporated herein by reference.

### FIELD

The present disclosure relates to a communication system and, more particularly, relates to a system for communications between a scout and a monitor.

### BACKGROUND

This section provides background information related to the present disclosure which is not necessarily prior art.

There are many situations in which one person depends on another to gather information and report back findings. For instance, law enforcement officers, soldiers, etc. can communicate and discover information in this manner. Specifically, a chief officer often sends out lower ranking officers into the field to investigate scenes of an accident or crime, interrogate witnesses, etc., and upon returning to the chief officer, the lower ranking officer can communicate the information back to the chief officer. However, gathering information in this word-of-mouth fashion can be time consuming. Also, the lower ranking officer may not notice certain details while on the fact-finding mission. Furthermore, the lower ranking officer might forget certain facts before reporting to the chief officer. Additionally, the chief officer may not sufficiently comprehend the situations encountered by the lower ranking officers even after hearing all of the details.

Also, communicating information from the chief officer to the lower ranking officers can be burdensome. For instance, in some instances, the chief officer can only communicate with the lower ranking officer after the fact-finding mission is over. As such, the chief may not be able to relay important information to the lower ranking officer at crucial times, and the investigation can be hindered as a result.

### SUMMARY

This section provides a general summary of the disclosure, and is not a comprehensive disclosure of its full scope or all of its features.

A communications system that provides two-way communication between a monitoring user and at least one scout is disclosed. With a camera, the scout gathers one or more images of an area that is immediate to the scout but remote from the monitoring user, and these images are communicated to the monitoring user. The monitoring user also communicates information to the scout.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a communications system according to exemplary embodiments of the present disclosure;

FIG. 2 is a first exemplary embodiment of a display of a monitoring user of the communications system of FIG. 1;

FIG. 3 is a second exemplary embodiment of a display of a monitoring user of the communications system of FIG. 1;

FIG. 4 is a third exemplary embodiment of a display of a monitoring user of the communications system of FIG. 1;

FIG. 5 is a fourth exemplary embodiment of a display of a monitoring user of the communications system of FIG. 1;

FIG. 6 is a fifth exemplary embodiment of a display of a monitoring user of the communications system of FIG. 1;

FIG. 7 is a sixth exemplary embodiment of a display of a monitoring user of the communications system of FIG. 1; and

FIG. 8 is an exemplary embodiment of a side-band protocol used by the communications system of FIG. 1.

Corresponding reference numerals indicate corresponding parts throughout the several views of the drawings.

### DETAILED DESCRIPTION

Example embodiments will now be described more fully with reference to the accompanying drawings.

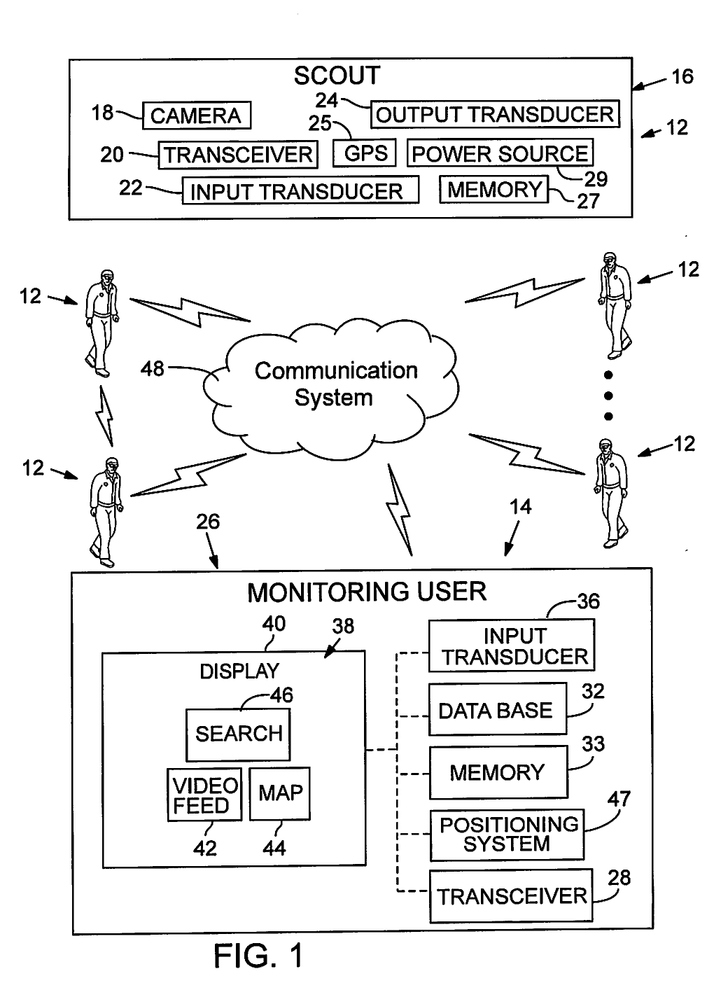

Referring initially to FIG. 1, a system 10 is illustrated according to various exemplary embodiments of the present disclosure. In general, the system 10 provides two-way communication between one or more scouts 12 (i.e., sentries) and a monitoring user 14 that are remote from each other. As will be described, the scouts 12 can gather one or more images of an area immediate to the particular scout 12, and these images can be transmitted to the monitoring user 14 so that the monitoring user 14 can remotely see what the scout 12 is seeing. Also, the monitoring user 14 can communicate information back to the scout 12 as will be discussed in greater detail below.

The system 10 can be implemented in a law enforcement environment. For instance, the monitoring user 14 can be a chief officer, and the scouts 12 can be lower ranking officers. The system 10 can also be implemented in military or other environments as well. An educator or supervisor in instructional environments may provide instructions to remote students or employees. First responders in emergency environments (such as emergency medical technicians or firefighters) may receive instructions from their captains or superiors located remotely. In commercial environments, a senior expert may provide instructions to junior experts who are in the field or on location (i.e., an insurance adjustor). Similarly, in military environments, a military officer may interact with remote troops.

It will be appreciated that there can be any number of scouts 12, and each can be equipped with a scouting device 16. The scouting device 16, the system 10, and methods of operation of the device 16 and system 10 can incorporate features described in Applicant's co-pending U.S. patent application Ser. No. 13/297,572, filed on Nov. 16, 2011 and/or U.S. patent application Ser. No. 12/870,458, filed Aug. 27, 2010, the entire disclosure of each being incorporated herein by reference. In some embodiments, at least part of the scouting device 16 can be a portable, head-mountable device, such as a pair of glasses or sunglasses.

As shown in FIG. 1, the scouting device 16 can include a camera 18. The camera 18 can gather video images (i.e., moving images or video) or still images (i.e., photographs or pictures). Moreover, the camera 18 can gather video images at any suitable number of frames per minute and at any suitable resolution. In some embodiments, the camera 18 can be a night-vision camera for capturing images in low light levels. Thus, as will be discussed, the camera 18 can gather images of the area surrounding the particular scout 12 (i.e. images of the immediate area to the scout 12).

The scouting device 16 can also include a transceiver 20. The transceiver 20 can provide two-way communication between the scout 12 and the monitoring user 14 as will be discussed.

The scouting device 16 can further include an input transducer 22, such as a microphone, a keyboard, buttons, etc. Information to be transmitted from the scout 12 to the monitoring user 14 can be input by the scout 12 into the input transducer 22.

Also, the scouting device 16 can include an output transducer 24, such as a speaker, a display, etc. Information received from the monitoring user 14 by the scout 12 can be output to the scout 12 by the output transducer 24.

The scouting device 16 can additionally include a positioning device 25. In some embodiments, the positioning device 25 can be linked to a regional satellite navigation system or a global satellite navigation system, such as GPS (the Global Positioning System), GLONASS, or Galileo, so that the positioning device 25 can automatically detect the position (e.g., latitude and longitude) of the scout 12. In some embodiments, the positioning device 25 can also automatically detect and update the position of the scout 12 while the scout 12 moves. Updating and refreshing of the scout's current position can occur at any predetermined time interval.

Furthermore, the scouting device 16 can include a memory unit 27. The memory unit 27 can be a computerized memory unit 27 including RAM, ROM, or other type of memory, and the memory unit 27 can have any suitable capacity. The memory unit 27 may accordingly incorporate either volatile memory or non-volatile memory (such as either NAND or NOR flash memory). In some embodiments, the memory unit 27 can save images gathered by the camera 18 or other information so that the information can be reviewed or transmitted at a later time.

The scouting device 16 may also include at least one power source 29, which may supply power to any or all of the parts of the scouting device 16. The power source 29 may be, for example, a lithium ion battery, but in various embodiments the power source 29 may alternatively be one or more of another type of rechargeable battery (such nickel-cadmium batteries), or one or more non-rechargeable batteries (such alkaline batteries). Moreover, in some embodiments, the power source 29 may include an adapter operable to plug in to an electrical outlet. When plugged into an electrical outlet, the power source 29 may supply power to the various parts of the scouting device 16 from a battery, or from the electrical outlet, or from both.

It will be appreciated that the scouting device 16 can be a portable unit. For instance, in some embodiments, at least some components of the scouting device 16 (e.g., the transceiver 20 and/or the transducers 22, 24) can be incorporated in a cellular telephone or other portable device. The camera 18 can be connected to the cellular telephone via a USB or other type of connector, whether wired or wireless.

In some embodiments, the camera 18 may be connected to the cellular telephone by an isochronous USB 2.0 connection, or by another type of isochronous interface. The camera 18 can transmit data serially or in parallel. In some embodiments, the camera 18 can transmit data both serially and in parallel. For example, the connector may be a high-performance serial bus or high-speed serial interface, such as an IEEE 1394 interface (a.k.a. FireWire), or a SATA (Serial ATA) interface, or a PCI Express interface, a USB 3.0 interface, In other embodiments, the camera 18 may transmit data wirelessly, such as by a Bluetooth connection.

Also, in some cases, the camera 18 can be such that the camera 18 substantially takes photographs or gathers video images of objects that are in the line of vision of the scout 12. Additionally, the scouting device 16 may include a device for detecting and providing an orientation, such as a magnetometer. For example, the positioning device 25 may include an orientation device, and may thus automatically detect and update both the position and the orientation of the scout 12 within the environment. That is, the scouting device 16 may detect a direction (such as a direction on a map) in which camera 18 is pointing. The scouting device 16 may thereby detect the direction of the line of vision of the scout 12.

However, it will be appreciated that the scouting device 16 could be incorporated into any suitable portable unit, and that the camera 18 could be mounted to any other portion of the scout's body or belongings. In additional embodiments, the camera 18 can be removably mounted to the scout's body or belongings (e.g., a clip-on camera 18 that removably clips onto the scout's body or belongings).

Accordingly, parts of the scouting device 16—such as the camera 18, the transceiver 20, the input transducer 22, the output transducer 24, the positioning device 25, the memory unit 27, and the power source 29—may be integrated with each other in a variety of ways. For example, one or more of the camera 18, the input transducer 22, and the output transducer 24 may be operably secured within or incorporated in a removable head-mounted device such as a pair of glasses or sunglasses.

Similarly, one or more of the positioning device 25, the memory unit 27, the power source 29, and the transceiver 20 may be incorporated in a portable unit or device, such as a cellular telephone. In some configurations, the transceiver 20 may be incorporated in a cellular telephone, while other parts of the scouting device 16 (such as the camera 18, the transceiver 20, the input transducer 22, and the output transducer 24) may be integrated with each other outside of the cellular telephone. In other configurations, some parts of the scouting device 16, such as the input transducer 22 and the output transducer 24, may be partially incorporated in a removable head-mounted device, and partially incorporated in a portable unit or device.

The system 10 additionally includes a monitoring device 26 that is available to the monitoring user 14. The monitoring device 26 can be incorporated within a personal computer, a cellular telephone, etc. The monitoring device 26 can also operate as a server that communicates with the different scouting devices 16. Alternatively, communications between the monitoring device 26 and the scouting devices 16 can rely on a server that is located “in the cloud” (i.e., remote to both scouts 12 and monitoring user 14) for so-called “cloud computing.”

The monitoring device 26 can generally include a transceiver 28. The transceiver 28 can provide two-way communication with the transceiver 20 of the scouting device 16 as will be discussed in greater detail below.

The monitoring device 26 can also have access to a database 32. The database 32 can include a memory 33, which may in turn contain a variety of stored data. The stored data can be in the form of maps, a listing of certain locales, previously saved longitude and latitude of certain locales, etc. The stored data can also include images, such as still images or video images captured by the cameras 18 in the scouting devices 16. The database 32 can be located on a server that is local to monitoring user 14, and/or the database 32 can be located remotely (e.g., via so-called “cloud” computing).

The monitoring device 26 can further include an input transducer 36, such as a microphone, a keyboard, buttons, or other type. As will be discussed, the monitoring user 14 can input information into the input transducer 36, which can transmit that information to output transducer 24 of a scouting device 16, which can then output that information to the scout 12.

Additionally, the monitoring device 26 can include an output transducer 38. The scout 12 can input information into the input transducer 22 of scouting device 16, the output transducer 38 can receive that information from the input transducer 22, and the output transducer 38 can then output that information to the monitoring user 14.

The output transducer 38 can include a speaker and/or a display 40 (i.e., screen, computer monitor, etc.). The display 40 can display video images on a video feed 42. For example, the display 40 can display video images gathered by the scout's camera 18. Thus, the monitoring user 14 can remotely view the area that the scout 12 is occupying.

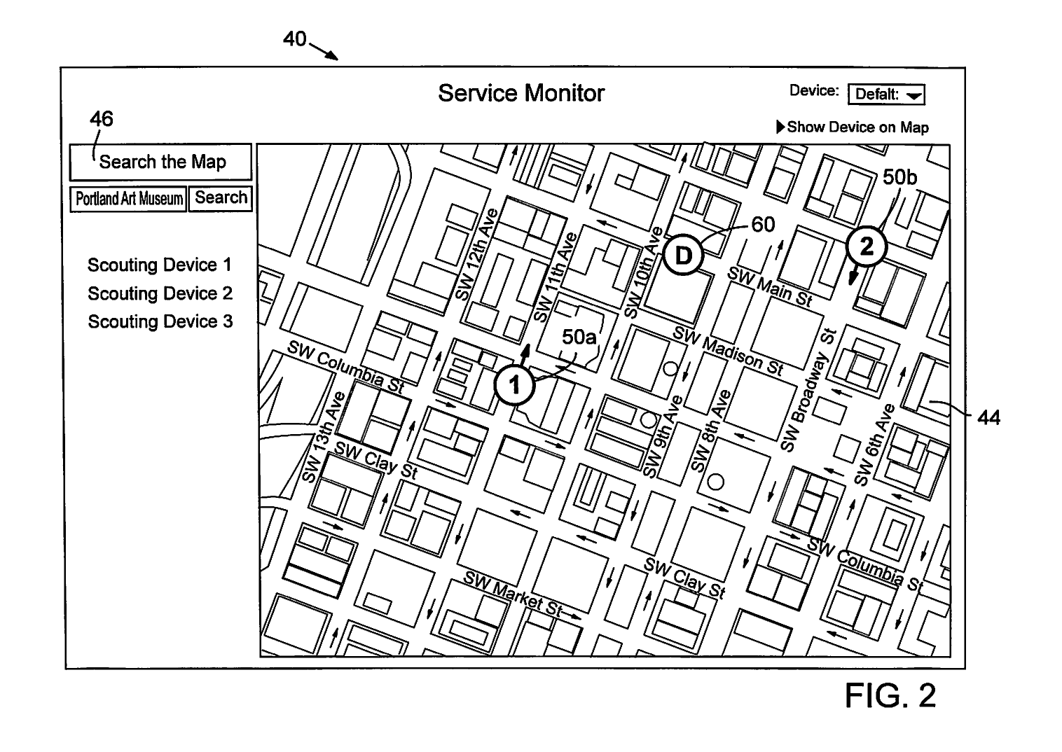

The display 40 can also display one or more maps 44 that are stored in the database 32. Although depicted in FIGS. 2-5 as being street a street map, maps 44 can be maps of any other type, such as elevational-view maps, on-street perspective maps, or topographical maps. Also, the display 40 can display the current latitude/longitude detected by the positioning device 25 of the scouting device 16.

Furthermore, the display 40 can display a search tool 46, which may interface with an Internet search engine. The search tool 46 can be used to perform a search for information (e.g., a search for the latitude and longitude of a certain locale, or a search for a certain locale by street address or by name, etc.) as will be discussed in greater detail. Other information can also be displayed on the display 40 as will be discussed.

Additionally, in some embodiments, the display 40 can display a website or other prepared content that has been customized according to the particular scout 12. This website can have a specific URL or address and can be password-protected.

The monitoring device 26 can also include a positioning system 47. The positioning system 47 can be in communication with GPS or other type of global satellite navigation system for determining the position (e.g., latitude and longitude) of the scout 12 and/or other remote locales. The positioning system 47 can communicate with the positioning device 25 of the scouting device 16.

An image stored in the database 32 (such as a video image) may be associated with the positioning information provided by the positioning devices 25 and the positioning system 27, such as latitude and longitude. Images may also be associated with date-stamps and/or time-stamps, as well as with information identifying the specific scouting device 16 used to gather the image.

Moreover, the system 10 can further include a communications system 48 that provides communication between the transceiver 20 of the scouting device 16 and the transceiver 28 of the monitoring device 26. For instance, the communications system 48 can be internet-based, can be a cellular telephone network, can be a wireless network, or can be a satellite communication system, can route information through an Internet cloud-based server, and can be of any suitable type (e.g., 3G, 4G, GSM/GPRS/Wi-Fi, LTE, etc.). Audio data can also be transmitted via conventional telephony (e.g., GSM, CDMA, etc.). The communications system 48 may therefore include a variety of technologies (i.e., internet-based, cellular-based, or satellite-based technologies) along the communications path between the transceiver 20 and the transceiver 28.

Also, visual, audio, and other data can be compressed and encoded for transfer over the communications system 48. For example, video images can be compressed in accordance with a standard such as MPEG-4 or H.264, then transferred over the communications system 48.

The transceiver 20 of the scouting device 16 may, accordingly, have a cellular network connection to the communication system 48. The transceiver 28 of the monitoring device 26 may then have its own cellular network connection to the communication system 48. These cellular network connections may include any suitable type or specification (e.g., 3G, 4G, LTE, GSM, GPRS, EV-DO, EDGE, HSDPA, or HSPA+). Alternatively, in some embodiments, communication system 48 may have a cellular network connection to transceiver 20, and may thereafter convert from the cellular network communications protocol to an internet communications protocol, for example, so that communication system 48 may have an internet-based connection to transceiver 28. The transceiver 28 may also have a wireless network connection to the communication system 48, such as an 802.11-compliant Wi-Fi connection (compliant with 802.11a, 802.11b, 802.11g, and/or 802.11n). It will be appreciated, however, that other communications systems 48 are also within the scope of the present disclosure.

Parts of the monitoring device 26—such as the transceiver 28, the database 32, the input transducer 36, the output transducer 38 (which may include the display 40), and the positioning system 47—may therefore be integrated with each other in a variety of ways. For example, in some configurations, the transceiver 28, the database 32, the input transducer 36, the display 40, and the positioning system 47 may be incorporated in a personal computer. In other configurations, at least the input transceiver 28, the input transducer 36, and the output transducer 38 (which may include the display 40) may be incorporated in a personal computer or a cellular telephone. In further configurations, the database 40 may, along with the positioning system 47, be incorporated in a server.

Accordingly, the communications system 48 can provide two-way communication between the monitoring user 14 and the scout 12. This communication can occur nearly real-time. In nearly real-time communication, data (such as video images gathered by the camera 18 or other data input to the input transducer 22) may be transmitted directly after being gathered by the scouting devices 16, may be streamed through the communication system 48, and may be received by the monitoring device 26 and directly displayed on display 40 and/or stored in memory 33. Such streaming may minimize the latency between the gathering of video images by the scouting device 16 and the viewing of the video images at the monitoring device 26.

As will be discussed in greater detail, the scout 12 can gather visual data via the camera 18 to be transmitted and displayed on the display 40 of the monitoring device 26. Also, the scout 12 can input other information (e.g., audible information, textual information, etc.) via the input transducer 22, and this information can be output to the monitor 14 via the output transducer 38. It will be appreciated that information input by the scout 12 can be translated and output to the monitor 14 in a different form, such as in a text-to-speech transmission, a speech-to-text transmission, etc.

Likewise, the monitor 14 can input information (e.g., audible information, textual information, etc.) via the input transducer 36, and this information can be output to the scout 12 via the output transducer 24. It will be appreciated that information input by the scout 12 can be translated and output to the monitor 14 in a different form, such as in a text-to-speech transmission, a speech-to-text transmission, etc.

Referring to FIGS. 1-7, methods of using the system 10 will now be discussed. In the embodiments shown, a plurality of scouts 12 is in communication with a single monitoring user 14. However, there can be any number of scouts 12 in communication with any number of monitoring users 14. In addition, two or more scouts 12 may be in communication with each other, and may form a distributed or peer-to-peer network with each other.

Exemplary embodiments of the display 40 of the monitoring device 26 are shown in FIGS. 2-7. As shown in FIG. 2, the monitoring user 14 can view a map 44 on the display 40. The display 40 can enable the monitoring user 14 to scroll within the map 44, zoom into and out of the map 44, and adjust the level of displayed map data. Particular locales may be made visible on the map, such as businesses, museums, street names, etc.

The display 40 may allow the monitoring user 14 of the system 10 to preview or otherwise determine which of the scouts 12 are available for a particular task. The current position of the scouts 12, or of the scouting devices 16 mounted on the scouts 12, may then be displayed or indicated on map 44 (e.g., via overlaid icons, etc.). More particularly, the monitoring user 14 may cause the scouting devices 16 to be shown on the map, as indicated in the upper-right-hand corner of display 40.

In the embodiments illustrated, a first icon 50a can indicate the position of a first scout 12, and a second icon 50b can indicate the position of a second scout 12 as determined by the positioning system 47 and/or the positioning devices 25. Although the monitoring user 14 has caused the scouting devices 16 to be shown on the map, a third scout 12 is at a position not falling within the displayed portion of map 44. The position of the third scout may accordingly not be indicated by an icon on map 44.

As shown, the icons 50a, 50b reveal that the first scout 12 is located at the intersection of Clay Street and 11^{th} Avenue while the second scout 12 is located at the intersection of Salmon Street and Broadway. These positions are detected by the positioning devices 25 of the respective scouting devices 16, and these positions can be continuously updated on the map 44 at regular time intervals to track movements of the scouts 12. In some embodiments, the icons 50a, 50b can also be linked to the names or other identifiers of the particular scouts 12, so that the monitoring user 14 can identify each scout 12.

In addition to indicating positions of the scouts 12, the display 40 can indicate the orientation of the scouts 12, or the scouting devices 16. For instance, as illustrated in FIGS. 2-5, the first icon 50a includes an arrow pointing north-east, and the second icon 50b includes an arrow pointing south-west. These orientations may be detected by a device for detecting and providing an orientation integrated within the scouting device 16, or integrated within part of the scouting device 16 such as the positioning device 25. For example, the positioning device 25 may detect the orientations of the scouts 12 within the environment, and may continuously update these orientations on the map 44 at regular time intervals to reflect the line of vision of the scouts 12. Furthermore, orientations may be calibrated to changes in position of the scouts 12. Thus, if the positioning device 25 is not integrated within a device oriented along the line of vision of the scouts 12 (such as glasses or sunglasses), detected orientations may be adjusted to reflect the direction of changes in position. Alternatively, orientations of the scouts 12 may be directly based upon changes in detected positions.

One or more of the scouting devices 16 (or the scouts 12 identified with the scouting devices 16) may also be listed within display 40. As depicted in FIG. 2, for example, the display 40 lists Scouting Device 1, Scouting Device 2, and Scouting Device 3. As will be discussed below, the monitoring user 14 may interact with this list of scouts (or scouting devices) to adjust the contents of display 40.

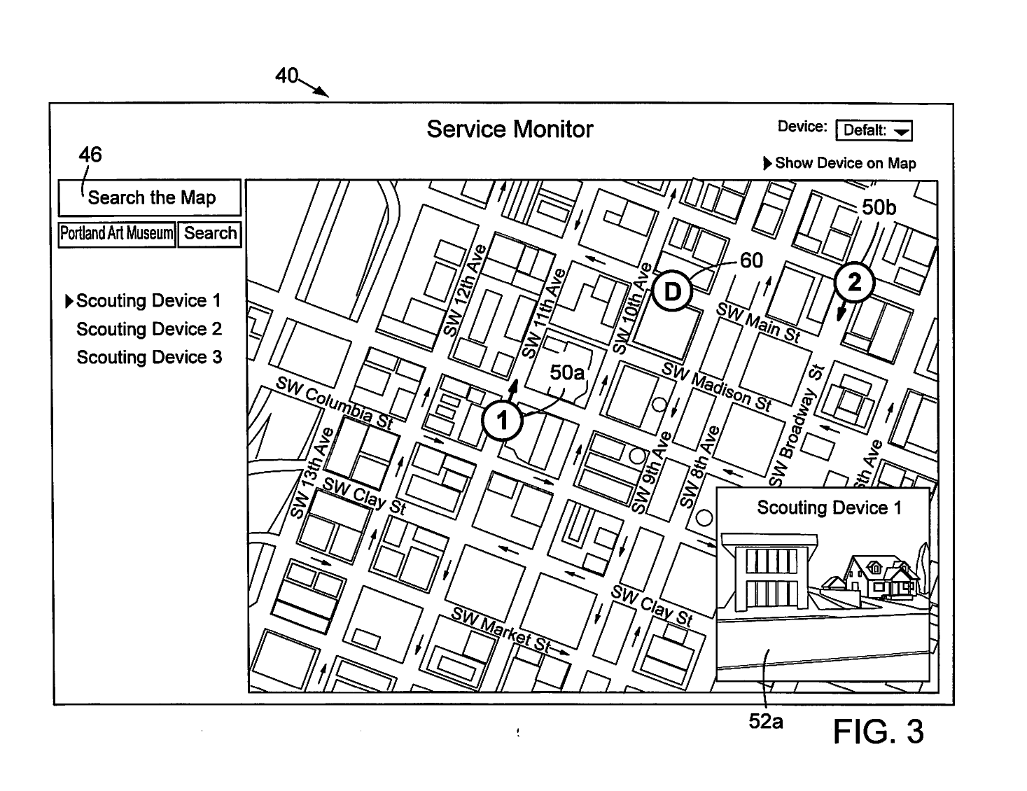

In addition to displaying the positions of the various scouts 16 on the map 44, the display 40 can also display images gathered by the scouts' cameras 18. For example, as shown in FIG. 3, the monitoring user 14 has selected Scouting Device 1 from the list of scouting devices. An image 52a gathered by the scouting device 16 of the first scout 12 is then superimposed on the map 44. The image 52a can be a video image being gathered in nearly real-time by the first scout 12 (i.e., at Clay Street and 11^{th} Avenue). Alternatively, the image 52a can be a stored image previously gathered by the first scout 12.

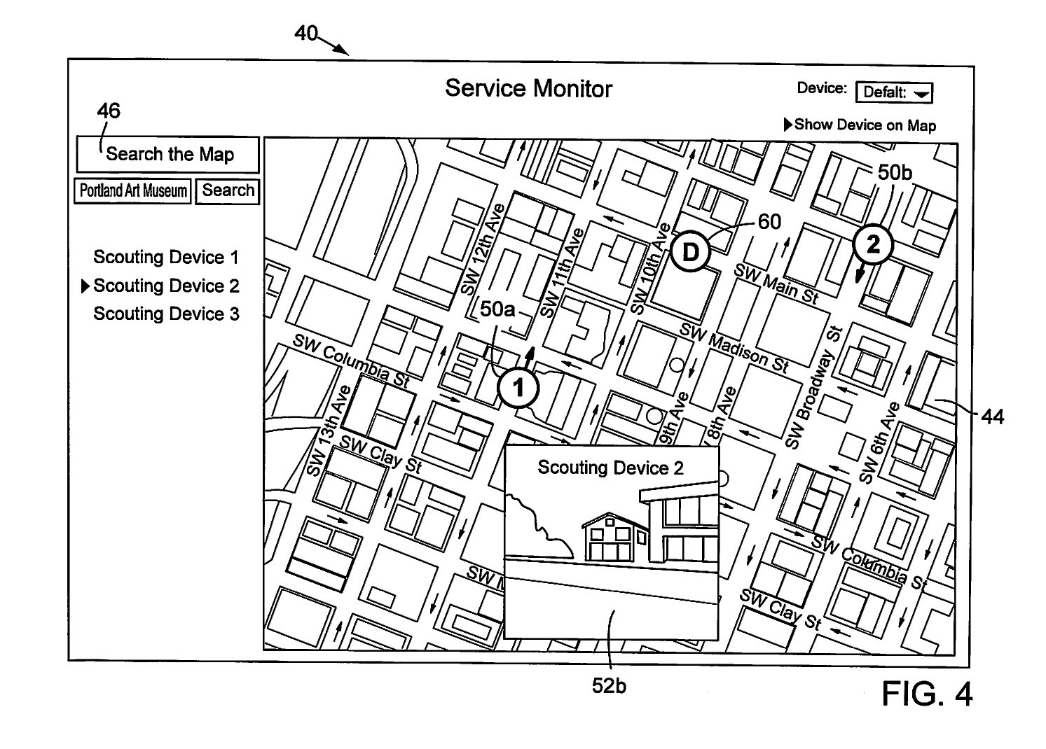

As shown in FIG. 4, the monitoring user 14 has instead selected Scouting Device 2 from the list of scouting devices, and an image 52b gathered by the scouting device 16 of the second scout 12 is superimposed on the map 44. As with the image 52a, the image 52b can be a video image being gathered in nearly real-time by the second scout 12 (i.e., at Salmon Street and Broadway), or the image 52b can be a stored image previously gathered by the second scout 12.

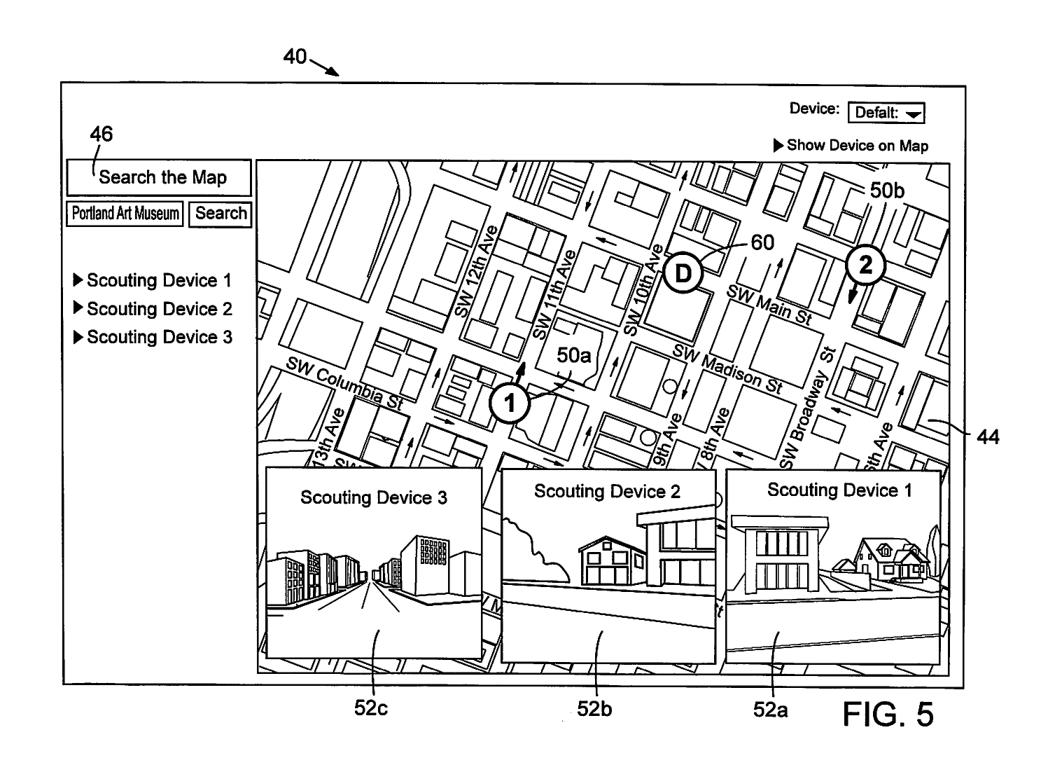

In some embodiments, the monitoring user 14 may select more than one of the scouting devices 16 from the list of scouting devices, and video images gathered by each of the selected scouting devices 16 may be superimposed on the map 44 simultaneously. For example, as shown in FIG. 5, the monitoring user 14 has selected all of the listed scouting devices 16—that is, the monitoring user 14 has selected Scouting Device 1, Scouting Device 2, and Scouting Device 3. Images 52a, 52b, and 52c gathered by the first scout 12, the second scout 12, and the third scout 12 respectively are then superimposed on the map 44.

Accordingly, in various embodiments, the monitoring user 14 can select one or more of the listed scouting devices, or may select one or more of icons on the map 44, such as the icons 50a, 50b. The respective images 52a, 52b, 52c may then be displayed on the display 40 as a result. Thus, the monitoring user 14 can see what each of the scouts 12 is seeing.

The movements of each scout 12 can be observed by the monitoring user 14 by viewing the movements of the icons 50a, 50b on the map 44 (FIGS. 2-5). In addition, while the scouts 12 travel, the monitoring user 14 can simultaneously view one or more of the images 52a, 52b, 52c (FIGS. 2-5) to observe the street-level perspective of the scouts 12.

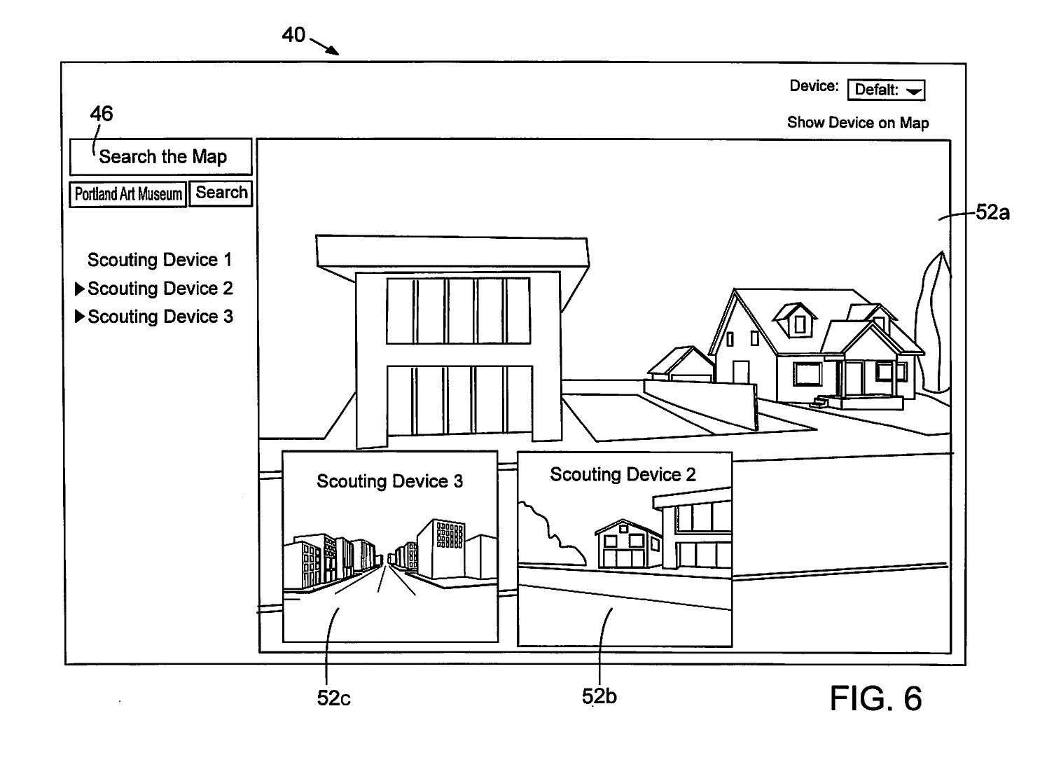

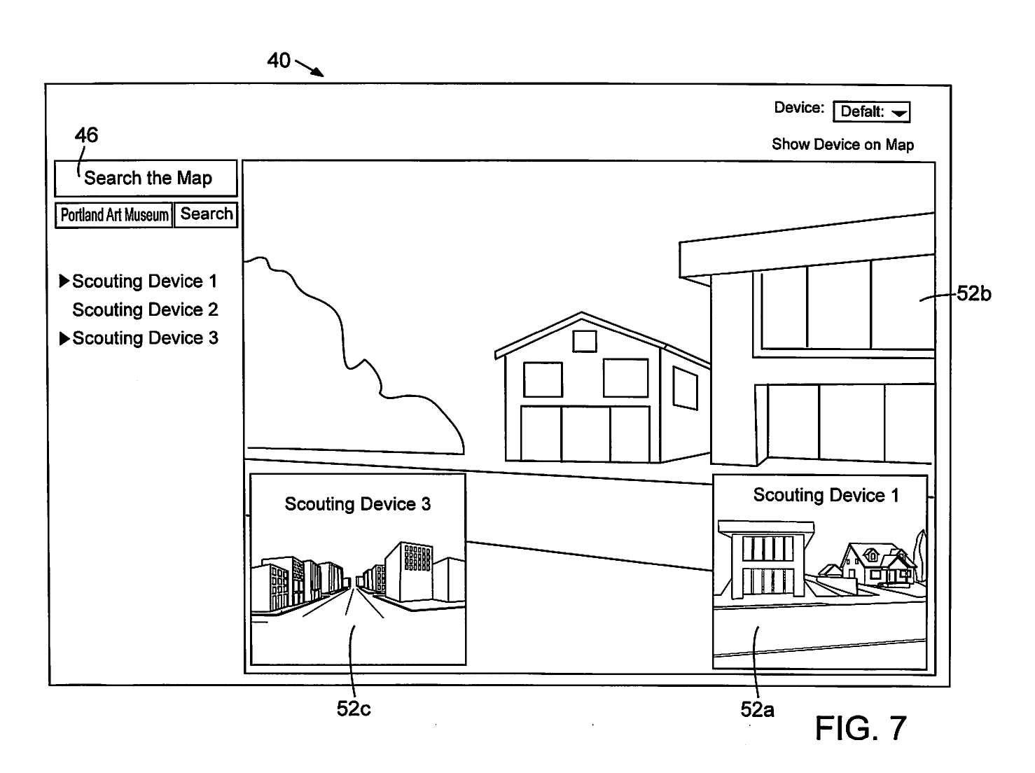

The monitoring user 14 can optionally change the size of a video image displayed on display 40. As shown in FIG. 6, for example, the display 40 does not display the map 44, but instead displays image 52a, i.e., a video image gathered by the first scout 12. The images 52b, 52c may then be superimposed over the image 52a. Similarly, as shown in FIG. 7, the display 40 displays the image 52b, and the images 52a, 52c are superimposed over the image 52b.

As a further alternative, display 40 may display another type of map, such as an elevational-view representation, or an on-street perspective view, or a still image, or other graphic representation corresponding with a portion of map 44 or a position on map 44. The monitoring user 14 may thereby access a variety of representations of positioning information and video images corresponding with the first, second and third scouts 12.

The monitoring user 14 and the scouts 12 can also communicate with each other (e.g., via speech, text, etc.) over the communication system 48. The monitoring user 14 can thereby instruct the scouts 12, and the scouts 12 can provide additional descriptions or reports regarding the remote area.

The display 40 can also display the search tool 46, as shown in FIGS. 2-7, and the monitoring user 14 may use the search tool 46 to search for a destination. In the embodiments illustrated, the monitoring user 14 has searched for “Portland Art Museum” using the search tool 46, and as a result of the search, a corresponding area of map 44 is displayed. Search results may also include street address and/or latitude and longitude information. The results of the search can be hyperlinked, and when the monitoring user 14 selects the results, an icon can be displayed on the map 44. More specifically, a destination icon 60 can appear on the map 44.

In some embodiments, once a destination has been selected by the monitoring user 14, directions to the destination can be sent from the monitoring user 14 to one or more of the scouts 12. For instance, the monitoring user 14 can personally communicate directions to the scouts 12 over the communication system 48.

Also, in some embodiments, the monitoring device 26 can automatically send directions to the positioning device 25 of the scouting device 16. In the latter case, the monitoring device 26 can transmit latitude and longitude of the destination to the scouting device 16, and this information can be processed by the scouting device 16 to thereby program the positioning device 25. As a result, turn-by-turn directions from scout's current location to the destination can be generated.

The search tool 46 may also be used to search by position (i.e., latitude and/or longitude), by date-stamp and/or time-stamp, and by scouting device. The database 32 may then return a list of the scout devices 16 corresponding with the search, and the monitoring user can select one or more of the corresponding scout devices 16 in order to display corresponding position information, or video images, or both, whether stored or being received in nearly real-time.

Depending upon the environment in which system 10 is used, it may be undesirable (or even unacceptable) for an individual scout 12 to be able to modify or delete a video image captured by the scouting device 16 used by the scout 12. In law enforcement environments, for example, evidence tampering is a potential danger. It may similarly be desirable to prevent access to video images captured by a scout 12 in a military environment, for purposes of maintaining operational security. It may also be desirable to prevent such access in an instructional environment, where access to various images may raise privacy issues.

Access to data gathered by the various scout devices 16 (i.e., video images and/or position information) may therefore be restricted depending upon account privilege or access restrictions corresponding with specific individual monitoring users 14. Some monitoring users 14 may thus have access to data from a wider range of the scouting devices 16 than other monitoring users 14 (whether that data had been previously gathered or is being gathered in nearly real-time). Access to data may, for example, be password-protected. Such access restrictions may accordingly facilitate secure maintenance of data.

Moreover, the nearly real-time gathering, transmission, and receipt or storage of video images may be advantageous in environments in which the integrity of gathered video images is important. In a law enforcement environment, or in commercial environments in which video images may serve as evidence, the nearly real-time streaming of video images to the monitoring device 26 may prevent intermediate modification of the video images. In contrast, video images gathered in the field and stored locally in the field for later storage in an official storage location might be subject to tampering before being stored at a later time in an official storage location.

Also, in some embodiments, the monitoring user 14 can transmit control commands to the scouting device 16. For instance, the monitoring user 14 can input control commands (via the input transducer 36) that are transmitted over the communications system 48 in order to control various operations of the scouting device 16. In some embodiments, these control commands can be used to turn the camera 180N and/or OFF. Also, these control commands can be used to focus or change a lens of the camera 18, switch between night-vision and daylight settings for the camera 18, etc. Control commands can also be used to control various functions of the other parts of the scouting device 16.

In some embodiments, for example, the monitoring user 14 can transmit a control command to a scouting device 16, which may in response begin capturing a video image. The video image may then be transmitted by the transceiver 22 through the communication system 48 to the transceiver 28, and may be stored in the memory 33 of the database 32. Subsequently, access restrictions (such as password-protection) may prevent access to, and modification or deletion of, the captured video image. The integrity of the captured video image may thereby be ensured by the monitoring user 14, working remotely from the scout 12.

At the same time, in various embodiments, the scouts 12 may be able to call the monitor or call for help. The scouts 12 may, for example, input an assistance command into input transducer 22. The assistance command may be speech captured by a microphone, or may be text entered by a keyboard or a button, or may be speech captured by a microphone and translated into text.

When a scout 12 inputs an assistance command calling the monitor, the monitoring device 26 may alert the monitoring user 14 to a specific request for assistance. The monitoring user 14 may then provide appropriate guidance to the scout 12 through the communication system 48.

When a scout 12 inputs and assistance command calling for help, the monitoring device 26 may alert the monitoring user 14 to a specific request for help, and the monitoring user 14 may then provide appropriate guidance to the scout 12, and may additionally transmit appropriate control commands to the scouting device 16. In addition, the monitoring device 26 may automatically take other actions, depending upon the emergency protocol for a particular environment.

For example, in an instructional environment, a call for help may automatically initiate a call to the 911 jurisdiction local to either the scout 12 making the call or the monitoring user 14. Alternatively, in a law enforcement or first responder environment, a call for help may automatically indicate a distress condition for the corresponding scouting device 16 on the display 40, and may automatically load a list of scouts 12 in close proximity to the scout 12 making the call for help. In a military environment, a call for help may automatically prevent control at the scouting device 16 of one or more features of the scouting device 16, such as the capability to turn on or turn off various parts of the scouting device 16.

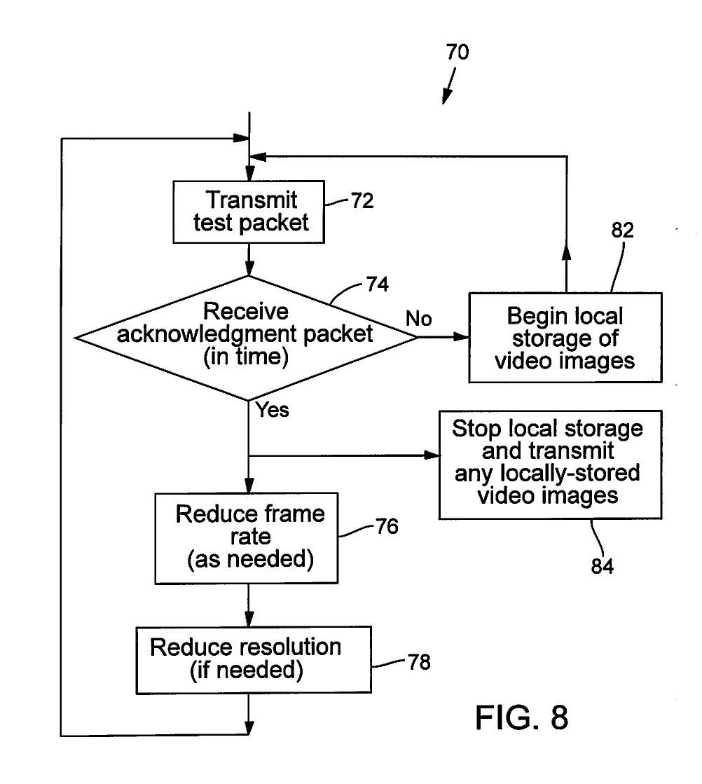

The scouting devices 15 and the monitoring device 26 may not always be in uninterrupted two-way communication with each other through the communication system 48. Accordingly, a side-band protocol may be used to control the manner in which the scouting devices 16 gather video images and compress, transmit, and optionally store them locally. FIG. 8 depicts an embodiment of a side-band control protocol 70 used by the communication system 10. In step 72 of the protocol, which occurs periodically over a set period of time, a test packet is transmitted from the scouting device 16 to the monitoring device 26. Then, in step 74, a determination is made as to whether the scouting device 16 has received an acknowledgement of the test packet from the monitoring device 26 within the set period of time.

If the acknowledgement has been timely received, the round-trip latency is determined. If the round-trip latency is not high enough to support the maximum frame rate and maximum video resolution, the frame rate of the video images being captured by the scouting device 16 is reduced in step 76 as needed to a level appropriate for the established round-trip latency. Then, in step 78, the resolution of the video images is reduced if needed to the level appropriate for the established round-trip latency.

However, if the acknowledgement is not timely received, then in step 82, video images gathered by the scouting device 16 begin to be stored in the memory unit 27, or in some other locally-available memory, i.e., a memory not accessed through the round-trip telecommunication path between the scouting device 16 and the monitoring device 26, whether available through a wired protocol or a wireless protocol. A locally-available memory may be, for example, an auxiliary memory device available through a wire-based connection, or a nearby memory device accessible wirelessly, such as through a Wi-Fi connection. Meanwhile, the scouting device 16 returns to step 72 and periodic transmission of test packets continues. Once an acknowledgement has been timely received, then any video images stored in the memory 27 are transmitted to the monitoring unit 16, and at the same time the frame rate and resolution are established as required in steps 76 and 78.

Accordingly, the scouting device 16 may determine in step 74 that test packets are not being timely acknowledged, which may indicate poor or unavailable connection to a cellular network. Then, in step 82, video images being gathered by the scouting device 16 may be locally stored in the memory unit 27, or may alternatively be transmitted through a Wi-Fi connection to a locally-available or nearby memory device. Subsequently, the scouting device 16 may determine in step 74 that test packets are being timely acknowledged. In step 84, the locally-stored video images may then be transmitted over the now-available cellular network connection, while the scouting device 16 resumes the nearly real-time gathering and transmission of video images to the monitoring device 26.

Accordingly, the system 10 enables communication of a wide variety of information between the monitoring user 14 and the scouts 12. The monitoring user 14 can see what the scouts 12 are seeing, for instance, and the monitoring user 14 can direct the scouts 12 to certain destinations 60, etc. Thus, the system 10 enables very effective information transfer between the monitoring user 14 and the scouts 12.

In various embodiments, for example, the system 10 may communicate video images captured by the scouts 12 to the monitoring user 14, and may provide two-way audio communication between the scouts 12 and the monitoring user 14. The system 10 may also enable the monitoring user 14 to track the scouts 12, both by position and through video images, and may enable real-time two-way communication between the monitoring user 14 and the scouts 12. The system 10 may thus assist the monitoring user 14 in providing real-time management, instruction, and command of the scouts 12.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for providing two-way communication between a monitoring user and one or more scouts remote from the monitoring user, the system comprising a monitoring device and a one or more scouting devices, each scouting device including:
a portable, body-mountable camera operable to capture a video image,
a positioning device operable to detect a position of the scout, and
a scout transceiver providing two-way communication between the scouting device and the monitoring device;
and the monitoring device including:
a monitoring transceiver providing two-way communication between the monitoring device and each of the scouting device, and
a display;
wherein each scouting device is operable to transmit the captured video image and the detected position to the monitoring device, and the display is operable to display each captured video image and to display each detected position on a map.

2. The system of claim 1, wherein the camera of each scouting device is operably secured within a pair of glasses.

3. The system of claim 1, wherein each scout transceiver is incorporated into a cellular telephone.

4. The system of claim 1, wherein the positioning device of each scouting device is operable to update the detected position when the scout moves.

5. The system of claim 1, wherein the scouting device further comprising a device for detecting and providing an orientation.

6. The system of claim 1, wherein each scouting device further includes a memory unit operable to save the captured video image.

7. The system of claim 1, wherein the monitoring device further includes a memory, each scouting device is operable to transmit captured video images in nearly real-time to the monitoring device, and the monitoring device is operable to receive a captured video image and store the captured video image in the memory.

8. The system of claim 1, wherein each scouting device further includes one of a microphone, a keyboard, and a button.

9. The system of claim 1, wherein each scouting device further includes one of a speaker and a display.

10. The system of claim 1, wherein the monitoring device further includes one of a microphone, a keyboard, and a button.

11. The system of claim 1, wherein each scout is selected from a group consisting of a soldier, a police officer, and a security officer.

12. A system for providing two-way communication between a monitoring user and one or more scouts remote from the monitoring user, the system comprising a monitoring device and one or more scouting devices, the monitoring device being in two-way communication with each of the scouting devices, each scouting device including:
a portable, body-mountable camera operable to capture a video image,
a positioning device operable to detect and update a position of the scout,
a memory unit operable to save video images captured by the camera,
a microphone operable to input audio information to transmit to the monitoring device,
a speaker operable to output audio information received from the monitoring device, and
a transceiver operable to transmit the captured video image and the detected position to the monitoring device;
and the monitoring device including a display operable to display each captured video image and to display each detected position on a map.

13. The system of claim 12, wherein the transceiver of each scouting device is incorporated into a cellular telephone.

14. The system of claim 12, wherein each scouting device further includes a memory unit operable to save the captured video image.

15. The system of claim 12, wherein each scouting device is operable to receive a control command.

16. The system of claim 15, wherein the control command is selected from a group consisting of a command to turn the camera on, a command to turn the camera on, a command to adjust a camera focus or camera lens, and a command to switch between a night-vision and a daylight setting.

17. A system for providing two-way communication between a monitoring user and a plurality of scouts remote from the monitoring user, the system comprising a monitoring device and a plurality of scouting devices, the monitoring device including:
a transceiver providing two-way communication between the monitoring device and each of the plurality of scouting devices, the transceiver being operable to receive a plurality of captured video images, and the transceiver being operable to receive a plurality of detected positions,
an input transducer operable to input information to transmit to each scouting device, and
a database operable to store a map and a plurality of positions,
a display operable to display the plurality of detected positions on the map and to display a video image overlaid on the map.

18. The system of claim 17, wherein the input transducer includes one of a microphone, a keyboard, and a button.

19. The system of claim 17, wherein the monitoring unit is operable to select one of the plurality of scouting devices, and the display is operable to display (a) a captured video image and (b) a detected position received from that scouting device.

20. The system of claim 17, wherein the monitoring device is operable to transmit a control command selected from a group consisting of a command to turn the camera on, a command to turn the camera on, a command to adjust a camera focus or camera lens, and a command to switch between a night-vision and a daylight setting.
